(19) United States
(12) Patent Application Publication
(10) Pub. No.: US 2007/0236420 A1
(43) Pub. Date: Oct. 11, 2007

(54) SOURCE DRIVER FOR DISPLAY AND DRIVING METHOD THEREOF

(75) Inventors: Jiunn-Yau Huang, Tainan County (TW); Cheng-Chi Yen, Tainan County (TW)

Correspondence Address: J C PATENTS, INC., 4 VENTURE, SUITE 250, IRVINE, CA, 92618, US

(73) Assignees: HIMAX TECHNOLOGIES LIMITED, Tainan County (TW); HIMAX DISPLAY, INC., Tainan County (TW)

(21) Appl. No.: 11/627,015

(22) Filed: Jan. 25, 2007

(30) Foreign Application Priority Data
Apr. 7, 2006 (TW) 95112368

(51) Int. Cl. G09G 3/30

(52) U.S. Cl. 345/76

(57) ABSTRACT

A source driver comprises a plurality of current-driving units, each of which includes a digital to analog converter (DAC), an operational amplifier, a first and second current source, a resistor, and a current mirror unit. The DAC converts programming data to an analog signal. The operational amplifier receives and amplifies the analog signal output from the DAC. The first current source generates a first current according to the amplified analog signal. The resistor is used to supply a feedback path from a reference voltage to the operational amplifier. The second current source outputs a second current according to a control signal generated by the display data. The current mirror unit mirrors a data current according to the sum of the first and second current to drive an organic light-emitting diode (OLED).

### CROSS-REFERENCE TO RELATED APPLICATION

This application claims the priority benefit of Taiwan application serial no. 95112368, filed on Apr. 7, 2006. All disclosure of the Taiwan application is incorporated herein by reference.

### BACKGROUND OF THE INVENTION

1. Field of Invention

The present invention relates to a source driver. More particularly, the present invention relates to a source driver without being affected by a voltage drop of an anode resistor of an organic light-emitting diode (OLED).

2. Description of Related Art

OLEDs, also referred to as organic electro-luminescent displays (OELDs), are self-luminescent elements. With the characteristics of DC low voltage driving capability, high luminance, high efficiency, high contrast value, lightweight, thinness, and high degree freedom of luminescent colors from three primary colors, red (R), green (G), and blue (B) to white (W), OLEDs are considered to be a key point in the development of the next-generation flat panel displays.

OLED technology not only has the same advantages of lightweight, thinness, and high resolution as a liquid crystal display (LCD) and the advantages of active luminescence, fast response, and power-saving cold light source, but also has the advantages of wide visual angle, preferable color contrast effect, low cost, and so on. Therefore, OLEDs can be widely used as LCDs or backlight sources for indicating boards, mobile phones, digital cameras, personal digital assistants (PDAs), and so on.

In view of the driving methods for the OLEDs, there are two types, namely passive matrix (PM) and active matrix (AM) driving methods. It should be noted that the OLEDs of the AMOLED and PMOLED have the same structure, but differ in circuit designs of OLED substrates.

A driving architecture for the PMOLED is quite simple. The OLED film is deposited between a transparent anode and a metal cathode which are perpendicularly crossed. Each pixel is lit up in a manner of scanning and sequentially turning on, and only one scan line of the gate driver is lit up at each time point, which means in order to achieve mean brightness required by the display, each lit point must be operated under a high voltage. As for the AMOLED, a thin film transistor (TFT) switch and a drive circuit are added in each OLED pixel, thereby adjusting continuous current through the LED.

In the conventional PMOLED, a source wiring of a source driver is usually used to output different data currents to drive the OLED element, thereby obtaining different grayscales and achieving the purpose of full color. However, the data currents output from the source driver of the conventional PMOLED are often affected by a voltage drop of an ITO resistor of the OLED, thus causing the problem of non-uniform display brightness of the OLED.

### SUMMARY OF THE INVENTION

Accordingly, the present invention provides a source driver, a display, and a method of driving a display panel, wherein a two-stage current mirror is utilized to provide a data current to drive an OLED, so as to eliminate adverse effects caused by an anode resistor of the OLED.

The source driver provided by the present invention comprises a plurality of current-driving units, each of which outputs a data current according to the display data, so as to drive a light-emitting element. Each current-driving unit comprises a digital to analog converter (DAC), an operational amplifier, a first current source, a second current source and a current mirror unit. The DAC is used to convert the programming data into a first analog signal and output it. The operational amplifier is used to receive and amplify the first analog signal, so as to output a second analog signal. The first current source generates a first current under control of the second analog signal. The second current source mirrors the first current by a factor, i.e., 2ⁿ, so as to obtain a second current, wherein the factor is determined according to the display data. The current mirror unit is coupled to the first current source and the second current source to mirror the sum of the first current and the second current, so as to output the data current.

From another aspect, the source driver provided by the present invention comprises a plurality of current-driving units, each of which outputs a data current according to the display data, so as to drive a light-emitting element. Each current-driving unit comprises a reference current generator and a current mirror unit, wherein the reference current generator generates a corresponding reference current according to the display data. The current mirror unit is coupled to the reference current generator to mirror the reference current generated by the reference current generator according to the programming data, so as to output the data current.

From still another aspect, the display provided by the present invention comprises a gate driver, a source driver and a display panel. The gate driver has a plurality of gate wirings for receiving a basic timing and sequentially outputting scanning voltages for each gate wiring. The source driver comprises a plurality of current-driving units, each of which outputs a data current according to the display data, so as to drive a light-emitting element. Each current-driving unit comprises a DAC, an operational amplifier, a first current source, a second current source and a current mirror unit. The DAC is used to convert the programming data into a first analog signal and then output it. The operational amplifier is used to receive and amplify the first analog signal and output a second analog signal.

The first current source generates the first current under the control of the second analog signal. The second current source mirrors the first current by a factor, i.e., 2ⁿ, so as to generate a second current, wherein the factor is determined according to the programming data. The current mirror unit is coupled to the first current source and the second current source to mirror the sum of the first current and the second current, so as to output the data current. The display panel is coupled to the gate driver and the source driver, and comprises a plurality of light-emitting elements, each of which is disposed between each source wiring and each gate wiring.

In another embodiment of the present invention, each current-driving unit comprises a reference current generator and a current mirror unit, wherein the reference current generator generates a corresponding reference current according to the programming data. The current mirror unit is coupled to the reference current generator to mirror the reference current generated by the reference current generator according to the programming data, so as to output the data current.

In one embodiment of the present invention, the reference current generator comprises a DAC, an operational amplifier, a first current source and a resistor. The DAC is used to convert programming data into a first analog signal and output it. The operational amplifier comprises a first receiving end, a second receiving end and an output end, wherein the first receiving end is used to receive the first analog signal, and the output end is used to output a second analog signal. The current generated by the first current source is controlled by the second analog signal. The first end of the resistor is coupled to the second receiving end of the operational amplifier and the first current source, and the second end of the resistor is coupled to a first potential.

In one embodiment of the present invention, the reference current generator further comprises a second current source, which mirrors the current generated by the first current source by a factor, i.e., 2ⁿ, wherein the factor is determined according to the programming data.

In one embodiment of the present invention, the display is a passive organic electro-luminescent display (OELD).

From another point of view, the present invention provides a method of driving a display panel which comprises a plurality of light-emitting elements that are arranged in arrays. The method provided by the present invention comprises first converting programming data into an analog signal; then, amplifying the analog signal to generate a first current according to the amplified analog signal; after that, mirroring the first current to output a second current and summing the first current and the second current to form a data signal; and finally, driving each enabled light-emitting element according to the data current.

In the aforementioned embodiments, the light-emitting elements are OLEDs or LEDs.

The source driver provided by the present invention generates the data current by using the two-stage current mirror to drive the OLED, thereby eliminating adverse effects caused by a voltage drop of an anode resistor of the OLED and permitting the brightness presented by the OELD to be uniform and stable.

To make aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of display according to one preferable embodiment of the present invention.

FIG. 2 is a circuit diagram of a current-driving unit of a source driver according to the embodiment.

FIG. 3 is a circuit diagram of the current-driving unit according to another embodiment of the present invention.

FIG. 4 is a flow chart of a method for driving the display panel according to one preferable embodiment of the present invention.

### DESCRIPTION OF EMBODIMENTS

The present invention aims at solving a brightness-non-uniform problem occurred in a frame presented by an OELD due to a voltage drop of an anode resistor of the OLED in the conventional art. Therefore, the present invention provides a source driver, a display and a method for driving the display panel to solve the aforementioned problem.

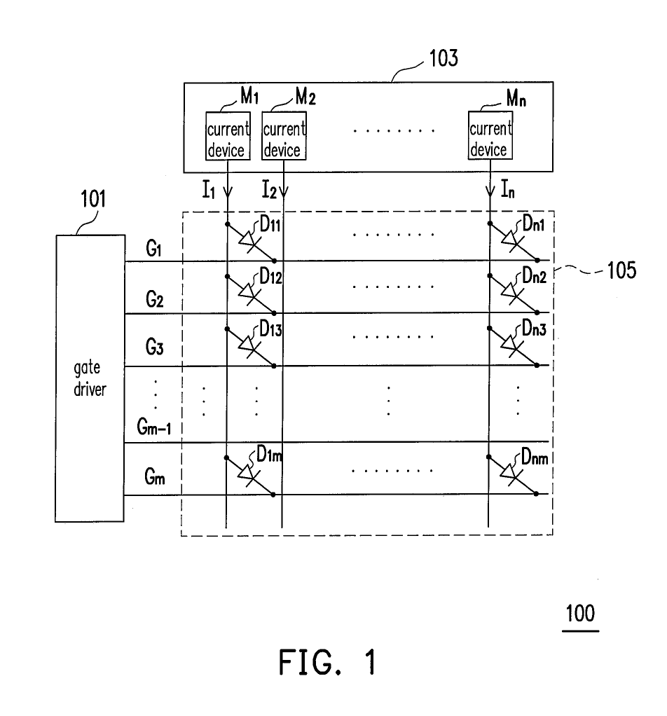

FIG. 1 is a block diagram of the display according to one preferable embodiment of the present invention. Referring to FIG. 1, the display 100 (for example, a passive OELD) comprises a gate driver 101, a source driver 103 and a display panel 105. The gate driver 101 comprises a plurality of gate wirings G1-Gm for receiving a basic timing and sequentially outputting a scanning voltage Vscan to each of the gate wirings G1-Gm. The source driver 103 comprises a plurality of current-driving units M1-Mn for receiving programming data and outputting data currents Id1-Idn to their corresponding source wirings I1-In.

The display panel 105 is coupled to the gate driver 101 and the source driver 103. The display panel 105 comprises a plurality of light-emitting elements (OLEDs or LEDs here) D11-Dnm, and each of the light-emitting elements D11-Dnm is disposed between each of the gate wirings G1-Gm and each of the source wirings I1-In. Each of the source wirings I1-In is coupled to its corresponding anode of each of the light-emitting elements D1-Dnm, and each of the gate wirings G1-Gm is coupled to its corresponding cathode of each of the light-emitting elements D11-Dnm.

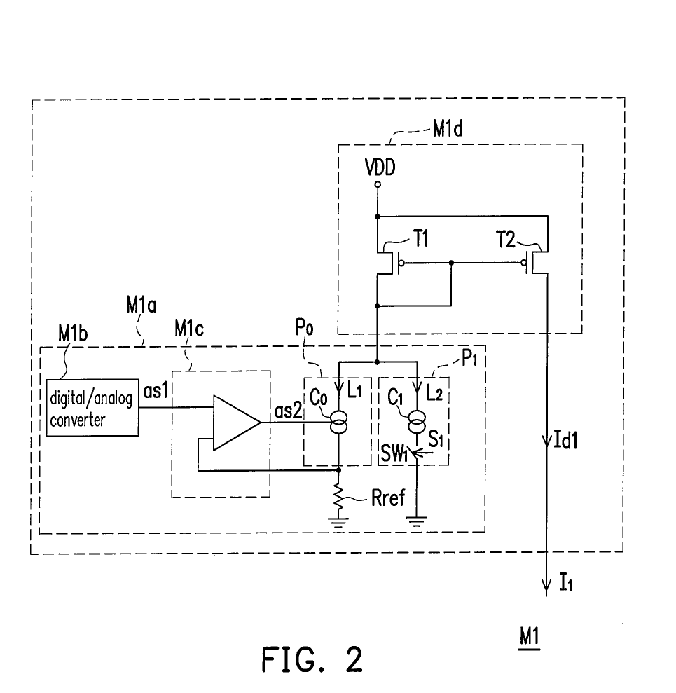

FIG. 2 is a circuit diagram of the current device M1 of the source driver 103 in the present embodiment. Referring to FIGS. 1 and 2, the current-driving unit M1 comprises a reference current generator M1a and a current mirror unit M1d, wherein the reference current generator M1a comprises a DAC M1b, an operational amplifier M1c, a first current source P0, a resistor Rref and a second current source P1.

In the present embodiment, the DAC M1b is used to convert the programming data into a first analog signal as1 and then output it. The operational amplifier M1c is used to receive and amplify the first analog signal as1 by a factor of, for example, 10, and output a second analog signal as2. The first input end of the operational amplifier M1c is used to receive the first analog signal as1, the second input end of the operational amplifier M1c is coupled to a first end of the resistor Rref and the first current source P0, and the output end of the operational amplifier M1c is used to output the second analog signal as2. Furthermore, a second end of the resistor Rref is coupled to a first potential, i.e., a ground potential, thereby providing a reference voltage required by a feedback path for the operational amplifier M1c.

The first current source P0 generates a first current L1 according to the second analog signal as2. The second current source P1 mirrors the first current L1 by a factor to generate a second current L2, wherein the factor is determined according to the display data. The second current source P1 may comprise a sub current source circuit C1 or a plurality of sub current source circuits C1-Cn. When the second current source P1 only comprises the sub current source circuit C1, the sub current source circuit C1 determines whether to provide a controlled current (not shown) according to the display data, wherein the controlled current b1 is just the second current L2. When the second current source P1 comprises the sub current source circuits C1-Cn, the sub current source circuits C1-Cn determine whether to provide the controlled circuits b1-bn (not shown) according to the display data, wherein the sum of the controlled currents b1-bn provided is the second current L2.

In the present embodiment, the sub current source circuit C1 comprises a controlled current source B1 (not shown) and a switch SW1, wherein the controlled current source B1 is used to provide the controlled current b1, and the switch SW1 is coupled between the controlled current source B1 and a second potential, i.e., a ground potential, and determines its on or off state according to a control signal S1 generated by the display data. In another embodiment of the present invention, the switch SW1 can also be coupled between the controlled current source B1 and the transistor T1. Furthermore, when the second current source P1 comprises the sub current source circuits C1-Cn, the circuit structure and coupling relation of each of the sub current source circuits C1-Cn are both similar to those of the sub current source circuit C1, so the on or off state is determined according to the control signals S1-Sn generated by the display data.

A current mirror unit M1d is coupled to the first current source P0 and the second current source P1 to mirror the sum of the first current L1 and the second current L2, thereby outputting a data current Id1. The data current Id1 is the sum of the first current L1 and the second current L2 because the currents L1 and L2 are connected in parallel. In the present embodiment, the current mirror unit M1d comprises a first transistor T1 (a P-type transistor here) and a second transistor T2 (a P-type transistor here). The drain of the transistor T1 is coupled to the drain of the transistor T2 and a second potential, i.e., a system voltage VDD, while the gate and the source of the transistor T1 are coupled together, and then coupled to the first current source P0 and the second current source P1. The gate of the transistor T2 is coupled to the gate of the transistor T1, and the source of the transistor T2 is coupled to a source wiring I1. In the present embodiment, the circuit structures and coupling relation of the current-driving units M2-Mn of the source driver 103 are both similar to the current-driving unit M1, which will not be described any more here.

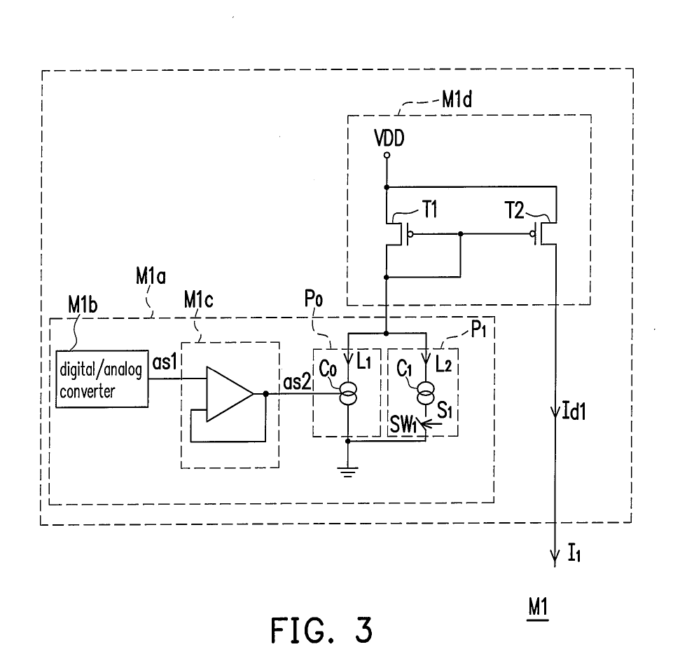

FIG. 3 is a circuit diagram of the current device M1 according to another embodiment of the present invention. Referring to FIGS. 2 and 3, the current-driving unit M1 in FIG. 3 is also applicable in the source driver 103. The current-driving unit M1 in FIG. 2 mainly differs the current-driving unit M1 in FIG. 3 in the coupling state of the operational amplifier M1c of the current-driving unit M1 in FIG. 3 and excluding the use of the resistor Rref, which, however, does not affect the spirit of the present invention. It is noted that the purpose of adding the resistor Rref into the current-driving unit M1 disclosed in FIG. 2 is to further stabilize the current-driving unit M1.

In the present embodiment, when the current-driving unit M1 of the source driver 103 receives the display data, the programming data is converted into the first analog signal as1 by the DAC M1b of the current-driving unit M1, and then the first analog signal as1 is amplified by the operational amplifier M1, so as to output the second analog signal as2. Then, the first current source P0 generates the first current L1 according to the size of the second analog signal as2, and the second current source P1 turns on the switch SW1 according to the control signal S1 generated by the programming data and generates a second current L2, current magnitude of which is equal to that of the first current L1.

After that, after receiving the data current Id1, the current mirror unit M1d mirrors and outputs the data current Id1 to the source wiring I1. According to the data current Id1 required by the programming data, it is only necessary to make the size of the second analog signal as2 output by the DAC M1b through the operational amplifier M1c be sufficient to generate half of the data current Id1, i.e., the first current L1. As such, the data current Id1 required by the programming data can also be acquired through the adding of the second current L2 generated by the second current source P1.

As described above, when the current-driving unit M2-Mn of the source driver 103 receive the display data, it is also converted into the data currents Id2-Idn through the current-driving units M2-Mn, and then the data currents Id2-Idn are output to the corresponding source wirings I2-In through the current mirror units M2c-Mnc of the current-driving units M2-Mn.

Next, the data currents Id1-Idn converted by the current-driving units M1-Mn of the source driver 103 are output to the corresponding source wirings I1-In, and drive each of the enabled light-emitting elements D11-Dnm together with the scanning voltages Vscan (low potentials here) output from the gate wirings G1-Gm of the gate driver 101.

According to the spirit of the present invention, the source wirings I1-In of the source driver 103 can also be correspondingly coupled to the cathodes of the light-emitting elements D11-Dnm, and the gate wirings G1-Gm are correspondingly coupled to the anodes of the light-emitting elements D11-Dnm. As such, each of the enabled light-emitting elements D11-Dnm can be driven only by replacing the first transistor T1 and the second transistor T2 in the current mirror units M1c-Mnc of the current-driving units M1-Mn with N-type transistors having the drains connected to the ground potential, and then coupling the switch SW1 of the current-driving units M1-Mn between the sub current source circuit C1 and the system voltage VDD, together with the scanning voltages Vscan (high potentials here) output from the gate wirings G1-Gm of the gate driver 101.

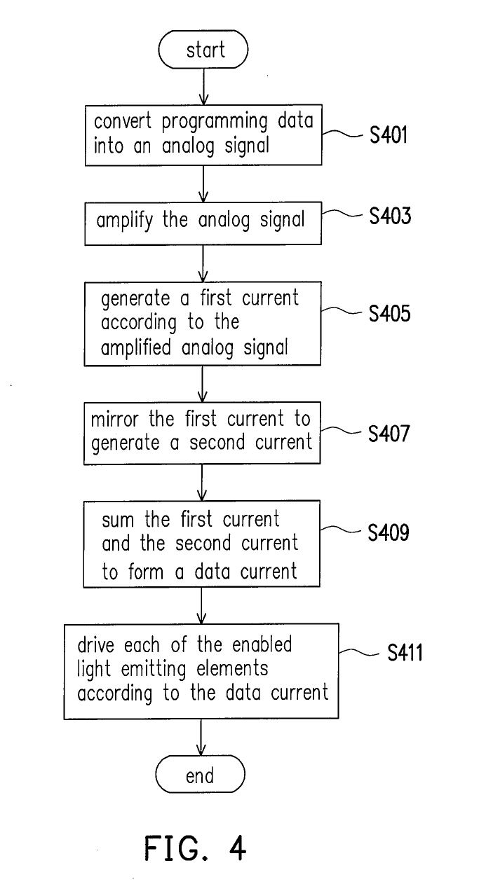

FIG. 4 is a flow chart of the method of driving the display panel according to one preferable embodiment of the present invention, wherein the display panel has a plurality of light-emitting elements arranged in arrays. The method comprises converting the programming data into the analog signal (Step S401); amplifying the analog signal (Step S403); generating the first current according to the amplified analog signal (Step S405); mirroring the first current and outputting the second current (Step S409); summing the first current and the second current to form the data current; and driving each of the enabled light-emitting elements according to the data current (Step S411).

In view of the above, since the source driver provided by the present invention generates the data current by using the two-stage current mirror, the source driver is not affected by the voltage drop of the anode resistor of the OLED, such that the frame presented by the OELD becomes more uniform and stable.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A source driver comprising:
a plurality of current-driving units for outputting a data current to drive a light-emitting element according to display data, wherein each of the current-driving units comprises:
a digital to analog converter (DAC) for converting programming data into a first analog signal;
an operational amplifier for buffering the first analog signal and outputting a second analog signal;
a first current source circuit for generating a first current in response to the second analog signal;
a second current source circuit for generating a second current derived by multiplying the first current by a factor determined according to the display data; and
a current mirror coupled to the first current source and the second current source, and outputting the data current by mirroring the sum of the first current and the second current.

2. The source driver as claimed in claim 1, wherein the current mirror comprises:
a first transistor having a first drain/source coupled to receive a first voltage, and a second drain/source and a gate commonly coupled to the first and second current source circuits; and
a second transistor having a first drain/source coupled to receive the first voltage, a gate coupled to the gate of the first transistor and a second drain/source outputting the data current.

3. The source driver as claimed in claim 1, wherein the second current source circuit comprises at least one sub current source circuit which is selectively activated to provide a controlled current which is a multiple of the first current according to the display data.

4. The source driver as claimed in claim 3, wherein each of the sub current source circuit comprises:
a current source for providing the controlled current; and
a switch coupled between the control current source and a second voltage, and controlled by the display data, wherein the sub current source circuit is activated and deactivated respectively when the switch is closed and opened.

5. The source driver as claimed in claim 1, wherein the operational amplifier has a first input receiving the first analog signal, and a second input and an output coupled together.

6. The source driver as claimed in claim 4, wherein the first voltage is a system voltage, the second voltage is a ground voltage, and the first and second transistors are P-type transistors.

7. The source driver as claimed in claim 4, wherein the first voltage is a ground voltage, the second voltage is a system voltage, the first and second transistors are N-type transistors.

8. The source driver as claimed in claim 1, wherein the factor is 2ⁿ.

9. The source driver as claimed in claim 1, wherein the light-emitting element is an organic light-emitting diode (OLED) or a light-emitting diode (LED).

10. A source driver comprising:
a plurality of current-driving units outputting a data current to drive a light-emitting element according to display data, each of which comprises:
a reference current generator for generating a reference current corresponding to the display data; and
a current mirror unit coupled to the reference current generator, for outputting the data current by mirroring the reference current.

11. The source driver as claimed in claim 10, wherein the reference current generator comprises:
a DAC for converting the programming data into a first analog signal and then outputting it;
an operational amplifier, comprising a first receiving end for receiving the first analog signal, a second receiving end, and an output end for outputting a second analog signal;
a first current source having the current generated under the control of the second analog signal; and
a resistor, comprising a first end coupled to the second receiving end of the operational amplifier and the first current source and a second end coupled to a first potential.

12. The source driver as claimed in claim 11, wherein the reference current generator further comprises:
a second current source mirroring the current generated by the first current source by a factor, wherein the factor is determined according to the display data.

13. The source driver as claimed in claim 12, wherein the factor is 2ⁿ.

14. The source driver as claimed in claim 12, wherein the second current source comprises at least one sub current source circuit which is selectively activated to provide a controlled current which is a multiple of the first current according to the display data.

15. The source driver as claimed in claim 14, wherein each of the one sub current source circuits comprises:
a control current source for providing the controlled current; and
a switch coupled between the control current source and a second voltage, and controlled by the display data, wherein the sub current source circuit is activated and deactivated respectively when the switch is closed and opened.

16. The source driver as claimed in claim 15, wherein the current mirror unit comprises:
a first transistor having a first drain/source coupled to receive a first voltage and a second drain/source coupled to receive the gate of the first transistor and a second current source outputting the data current; and
a second transistor having a first drain/source coupled to receive the first voltage, a gate coupled to the gate of the first transistor and a second drain/source outputting the data current.

17. The source driver as claimed in claim 16, wherein when the first is a system voltage, the second voltage is a ground voltage and the first and the second transistors are P-type transistors.

18. The source driver as claimed in claim 16, wherein when the first voltage is a ground voltage, the second potential is a system voltage and the first and the second transistors are N-type transistors.

19. The source driver as claimed in claim 10, wherein the light-emitting element is an OLED or an LED.

20. A display, comprising:
a gate driver sequentially outputting scanning voltages through a plurality of gate lines;
a source driver having a plurality of current-driving units, for outputting data currents through a plurality of data lines according to display data, wherein each of the current-driving units comprises:
a DAC for converting programming data into a first analog signal;
an operational amplifier for buffering the first analog signal and output a second analog signal;
a first current source circuit for generating a first current in response to the second analog signal;
a second current source circuit for generating a second current derived by multiplying the first current by a factor determined according to the display data; and
a current mirror unit coupled to the first and second current source circuits, for outputting one of the data currents by mirroring the sum of the first current and the second current; and
a display panel coupled to the gate driver and the source driver, and having a plurality of light-emitting elements, wherein each of the light-emitting element is respectively coupled between one of the source lines and one of the gate lines.

21. The display as claimed in claim 20, wherein the anode and the cathode of each of the light-emitting devices are respectively coupled to the source and gate lines, or the anode and the cathode of each of the light-emitting devices are respectively coupled to the gate and source lines.

22. The display as claimed in claim 20, wherein the current mirror unit comprises:
a first transistor having a first drain/source coupled to a first voltage, and a second drain/source and a gate commonly coupled to the first and the second current source circuits; and
a second transistor having a first drain/source coupled to the first voltage, a gate coupled to the gate of the first transistor and a second drain/source outputting the data current.

23. The display as claimed in claim 20, wherein the second current source comprises at least one sub current source circuits, which is selectively activated to provide a controlled current which is a multiple of the first current according to the display data.

24. The display as claimed in claim 23, wherein each of the sub current source circuit comprises:
a control current source for providing the controlled current; and
a switch coupled between the control current source and a second voltage and controlled by the display data, wherein the sub current source circuit is activated and deactivated respectively when the switch is closed and opened.

25. The display as claimed in claim 20, wherein the operational amplifier has a first input receiving the first analog signal, and a second input and an output coupled together.

26. The display as claimed in claim 24, wherein when the first voltage is a system voltage, the second potential is a ground voltage and the first transistor and the second transistor are P-type transistors.

27. The display as claimed in claim 24, wherein when the first voltage is a ground voltage, the second potential is a system voltage and the first transistor and the second transistor are N-type transistors.

28. The display as claimed in claim 20, wherein the factor is 2ⁿ.

29. The display as claimed in claim 20, wherein the light-emitting element is an OLED or an LED.

30. The display as claimed in claim 20, wherein the display is a passive organic electro-luminescent display (OELD).

31. A display, comprising:
a gate driver having a plurality of gate wirings, for receiving a basic timing and sequentially outputting a scanning voltage for each of the gate wirings;
a source driver having a plurality of current-driving units to output a data current according to a programming data so as to drive a light-emitting element, wherein each of the current-driving units comprises:
a reference current generator for generating a corresponding reference current according to the programming data; and
a current mirror unit coupled to the reference current generator, for mirroring the reference current to output the data current; and
a display panel coupled to the gate driver and the source driver, and having a plurality of light-emitting elements, each of which is respectively disposed between each of the source wirings and each of the gate wirings.

32. The display as claimed in claim 31, wherein the anode or cathode of each of the light-emitting elements is coupled to each of the source wirings and each of the gate wirings is coupled to the anode or the cathode of each of the light-emitting elements that is not coupled to each of the source wirings.

33. The display as claimed in claim 31, wherein the reference current generator comprises:
a DAC for converting the programming data into a first analog signal and then output it;
an operational amplifier, comprising a first receiving end for receiving the first analog signal, a second receiving end, and an output end for outputting a second analog signal;
a first current source having the current generated under the control of the second analog signal; and
a resistor, comprising a first end coupled to the second receiving end of the operational amplifier and the first current source and a second end coupled to a first potential.

34. The display as claimed in claim 33, wherein the reference current generator further comprises:
a second current source mirroring the current generated by the first current source by a factor, wherein the factor is determined by the display data.

35. The display as claimed in claim 34, wherein the factor is 2n.

36. The display as claimed in claim 34, wherein the second current source comprises at least one sub current source circuit which is selectively activated to provide a controlled current which is a multiple of the first current according to the display data.

37. The display as claimed in claim 36, wherein each of the sub current source circuits comprises:
a control current source for providing the controlled current; and
a switch coupled between the control current source and a second voltage, and controlled by the display data, wherein the sub current source circuit is activated and deactivated respectively when the switch is closed and opened.

38. The display as claimed in claim 31, wherein the current mirror unit comprises:
a first transistor having a first drain/source coupled to receive a first voltage, and a second drain/source and a gate commonly coupled to the first and second current source circuits; and
a second transistor having a first drain/source coupled to receive the first voltage, a gate coupled to the gate of the first transistor and a second drain/source outputting the data current.

39. The display as claimed in claim 38, wherein when the first voltage is a ground voltage, the second potential is a system voltage and the first and the second transistors are P-type transistors.

40. The display as claimed in claim 38, wherein when the first potential is a system voltage, the second potential is a ground voltage and the first and the second transistors are N-type transistors.

41. The display as claimed in claim 31, wherein the light-emitting element is an OLED or an LED.

42. The display as claimed in claim 31, wherein the display comprises a passive OELD.

43. A method for driving a display panel, wherein the display panel comprises a plurality of light-emitting elements arranged in an array, the method comprising:
converting a programming data into an analog signal;
amplifying the analog signal;
generating a first current according to the amplified analog signal;
mirroring the first current and then outputting a second current;
summing the first current and the second current to form a data current; and
driving each of the enabled light-emitting elements according to the data current.

44. The method as claimed in claim 43, wherein the light-emitting elements are OLEDs or LEDs.
